(19) United States
(12) Patent Application Publication
(10) Pub. No.: US 2023/0418822 A1
(43) Pub. Date: Dec. 28, 2023

(54) METHOD AND SYSTEM FOR CONFIGURABLE DATA ANALYTICS PLATFORM

(71) Applicant: JPMorgan Chase Bank, N.A., New York, NY (US)

(72) Inventors: Hong JI, Dix Hills, NY (US); Liang ZHOU, New York, NY (US); Christopher J. LEASOR, Fair Haven, NJ (US); Rakesh PATHAK, Millburn, NJ (US); Victor ANTARAMIAN, Ridgewood, NJ (US); Jay KATUKURI, San Jose, CA (US)

(73) Assignee: JPMorgan Chase Bank, N.A., New York, NY (US)

(21) Appl. No.: 17/808,825

(22) Filed: Jun. 24, 2022

(51) Int. Cl. G06F 16/2455; G06F 16/2457; G06F 16/242

(52) U.S. Cl. CPC G06F 16/24553; G06F 16/2457; G06F 16/2433

(57) ABSTRACT

A method and system for providing a data analytics platform that facilitates efficient feature delivery based on reusability of software modules are provided. The method includes receiving a job request that corresponds to a feature desired by a user; transforming the job request into a directed acyclic graph (DAG) that includes a set of operations; and constructing a software program that is configured to execute the set of operations included in the DAG. The transformation is performed by extracting a set of configuration instructions that respectively correspond to operations included in the set of operations from the job request. The construction of the software program is performed by retrieving software modules that are configured to execute operations included in the DAG from a library that stores a plurality of reusable software modules that respectively correspond to algorithm functions.

### BACKGROUND

### 1. Field of the Disclosure

This technology generally relates to methods and systems for providing a data analytics platform, and more particularly to methods and systems for using a configuration-based approach to provide a data analytics platform that facilitates efficient feature delivery based on reusability of software modules.

### 2. Background Information

For a large firm or organization that relies on software to perform various functions, a large amount of time and effort is expended by data engineers, scientists, and software developers to build software and data pipelines. In many instances, such software development projects entail the generation of code modules that have previously been developed and deployed. This repetition is time consuming and also prone to avoidable errors.

Accordingly, there is a need for a methodology for using a configuration-based approach to provide a data analytics platform that facilitates efficient feature delivery based on reusability of software modules.

### SUMMARY

The present disclosure, through one or more of its various aspects, embodiments, and/or specific features or sub-components, provides, inter alia, various systems, servers, devices, methods, media, programs, and platforms for using a configuration-based approach to provide a data analytics platform that facilitates efficient feature delivery based on reusability of software modules.

According to an aspect of the present disclosure, a method for providing a data analytics platform that facilitates efficient feature delivery based on reusability of software modules is provided. The method is implemented by at least one processor. The method includes: receiving, by the at least one processor, a job request that corresponds to a feature desired by a user; transforming, by the at least one processor, the job request into a directed acyclic graph (DAG) that includes a set of operations; and constructing, by the at least one processor, a software program that is configured to execute the set of operations included in the DAG.

The method may further include: receiving a set of input data; generating a set of output data by applying the software program to the input data; and generating a set of software construction data based on a result of the transforming, the constructing, and the applying of the software program to the input data.

The transforming may include extracting, from the job request, a set of configuration instructions that respectively correspond to operations included in the set of operations.

The constructing may include retrieving, from a library that stores a plurality of reusable software modules that respectively correspond to algorithm functions, at least one software module that is configured to execute at least one operation from among the set of operations included in the DAG.

The plurality of reusable software modules may include at least one operation handler module that defines an operation type attribute that corresponds to an operation included in the set of operations.

The plurality of reusable software modules may include at least one user defined function (UDF) that has a name attribute that corresponds to an identification, a class attribute that corresponds to a function type, and an initialization attribute that corresponds to initializing an instance of the at least one UDF.

The constructing may further include applying an artificial intelligence (AI) algorithm that uses a machine learning (ML) technique to determine which software modules, from among the plurality of software modules stored in the library, are configured to execute the at least one operation. The AI algorithm may be trained by using historical ground truth data.

The method may further include: appending the software construction data to the historical ground truth data to form an enhanced set of training data; and retraining the AI algorithm by using the enhanced set of training data.

Each operation included in the set of operations may be compatible with a Spark Structured Query Language (SQL) module for structured data processing.

According to another aspect of the present disclosure, a computing apparatus for providing a data analytics platform that facilitates efficient feature delivery based on reusability of software modules is provided. The computing apparatus includes a processor; a memory; and a communication interface coupled to each of the processor and the memory. The processor is configured to: receive, via the communication interface, a job request that corresponds to a feature desired by a user; transform the job request into a directed acyclic graph (DAG) that includes a set of operations; and construct a software program that is configured to execute the set of operations included in the DAG.

The processor may be further configured to: receive, via the communication interface, a set of input data; generate a set of output data by applying the software program to the input data; and generate a set of software construction data based on a result of the transformation, the construction, and the application of the software program to the input data.

The processor may be further configured to transform the job request into the DAG by extracting, from the job request, a set of configuration instructions that respectively correspond to operations included in the set of operations.

The processor may be further configured to construct the software program by retrieving, from a library that stores a plurality of reusable software modules that respectively correspond to algorithm functions, at least one software module that is configured to execute at least one operation from among the set of operations included in the DAG.

The plurality of reusable software modules may include at least one operation handler module that defines an operation type attribute that corresponds to an operation included in the set of operations.

The plurality of reusable software modules may include at least one user defined function (UDF) that has a name attribute that corresponds to an identification, a class attribute that corresponds to a function type, and an initialization attribute that corresponds to initializing an instance of the at least one UDF.

The processor may be further configured to construct the software program by applying an artificial intelligence (AI) algorithm that uses a machine learning (ML) technique to determine which software modules, from among the plurality of software modules stored in the library, are configured to execute the at least one operation. The AI algorithm may be trained by using historical ground truth data.

The processor may be further configured to: append the software construction data to the historical ground truth data to form an enhanced set of training data; and retrain the AI algorithm by using the enhanced set of training data.

Each operation included in the set of operations may be compatible with a Spark Structured Query Language (SQL) module for structured data processing.

According to yet another aspect of the present disclosure, a non-transitory computer readable storage medium storing instructions for providing a data analytics platform that facilitates efficient feature delivery based on reusability of software modules is provided. The storage medium includes executable code which, when executed by a processor, causes the processor to: receive a job request that corresponds to a feature desired by a user; transform the job request into a directed acyclic graph (DAG) that includes a set of operations; and construct a software program that is configured to execute the set of operations included in the DAG.

When executed by the processor, the executable code may further cause the processor to: receive a set of input data; generate a set of output data by applying the software program to the input data; and generate a set of software construction data based on a result of the transformation, the construction, and the application of the software program to the input data.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for using a configuration-based approach to provide a data analytics platform that facilitates efficient feature delivery based on reusability of software modules.

FIG. 4 is a flowchart of an exemplary process for implementing a method for using a configuration-based approach to provide a data analytics platform that facilitates efficient feature delivery based on reusability of software modules.

FIG. 5 is a flow diagram that illustrates a core engine with extension points for a system that implements a configuration-based approach to provide a data analytics platform that facilitates efficient feature delivery based on reusability of software modules, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

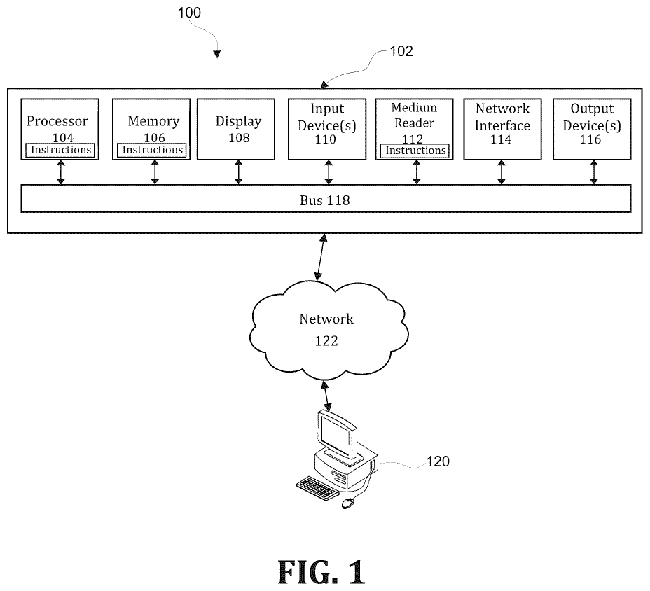

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for using a configuration-based approach to provide a data analytics platform that facilitates efficient feature delivery based on reusability of software modules.

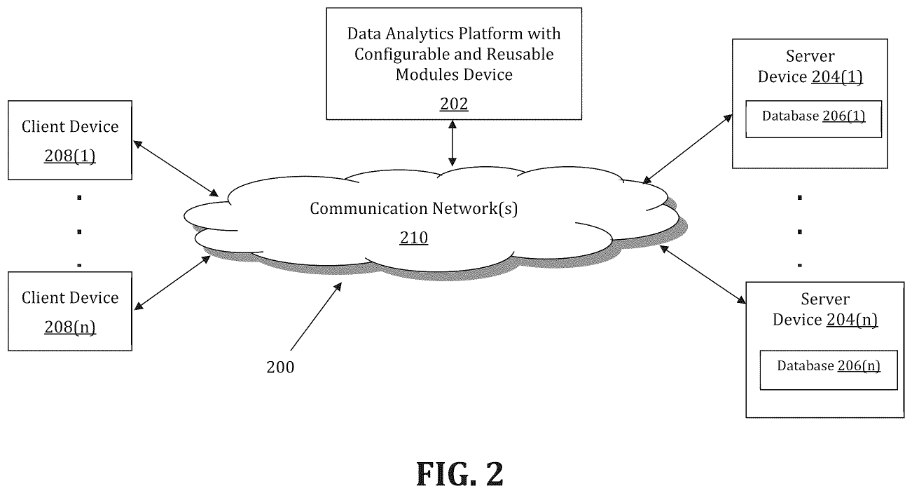

Referring to FIG. 2, a schematic of an exemplary network environment 200 for implementing a method for using a configuration-based approach to provide a data analytics platform that facilitates efficient feature delivery based on reusability of software modules is illustrated. In an exemplary embodiment, the method is executable on any networked computer platform, such as, for example, a personal computer (PC).

The method for using a configuration-based approach to provide a data analytics platform that facilitates efficient feature delivery based on reusability of software modules may be implemented by a Data Analytics Platform with Configurable and Reusable Modules (DAPCRM) device 202. The DAPCRM device 202 may be the same or similar to the computer system 102 as described with respect to FIG. 1. The DAPCRM device 202 may store one or more applications that can include executable instructions that, when executed by the DAPCRM device 202, cause the DAPCRM device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the DAPCRM device 202 itself, may be located in virtual server(s) running in a cloud-based computing environment rather than being tied to one or more specific physical network computing devices. Also, the application(s) may be running in one or more virtual machines (VMs) executing on the DAPCRM device 202. Additionally, in one or more embodiments of this technology, virtual machine(s) running on the DAPCRM device 202 may be managed or supervised by a hypervisor.

In the network environment 200 of FIG. 2, the DAPCRM device 202 is coupled to a plurality of server devices 204(1)-204(n) that hosts a plurality of databases 206(1)-206(n), and also to a plurality of client devices 208(1)-208(n) via communication network(s) 210. A communication interface of the DAPCRM device 202, such as the network interface 114 of the computer system 102 of FIG. 1, operatively couples and communicates between the DAPCRM device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the DAPCRM device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and DAPCRM devices that efficiently implement a method for using a configuration-based approach to provide a data analytics platform that facilitates efficient feature delivery based on reusability of software modules.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The DAPCRM device 202 may be a standalone device or integrated with one or more other devices or apparatuses, such as one or more of the server devices 204(1)-204(n), for example. In one particular example, the DAPCRM device 202 may include or be hosted by one of the server devices 204(1)-204(n), and other arrangements are also possible. Moreover, one or more of the devices of the DAPCRM device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the DAPCRM device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store historical data that relates to software developments and deployments and a library of algorithm functions.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the DAPCRM device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the DAPCRM device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the DAPCRM device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the DAPCRM device 202, the server devices 204(1)-204(n), or the client devices 208(1)-208(n), for example, may be configured to operate as virtual instances on the same physical machine. In other words, one or more of the DAPCRM device 202, the server devices 204(1)-204(n), or the client devices 208(1)-208(n) may operate on the same physical device rather than as separate devices communicating through communication network(s) 210. Additionally, there may be more or fewer DAPCRM devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

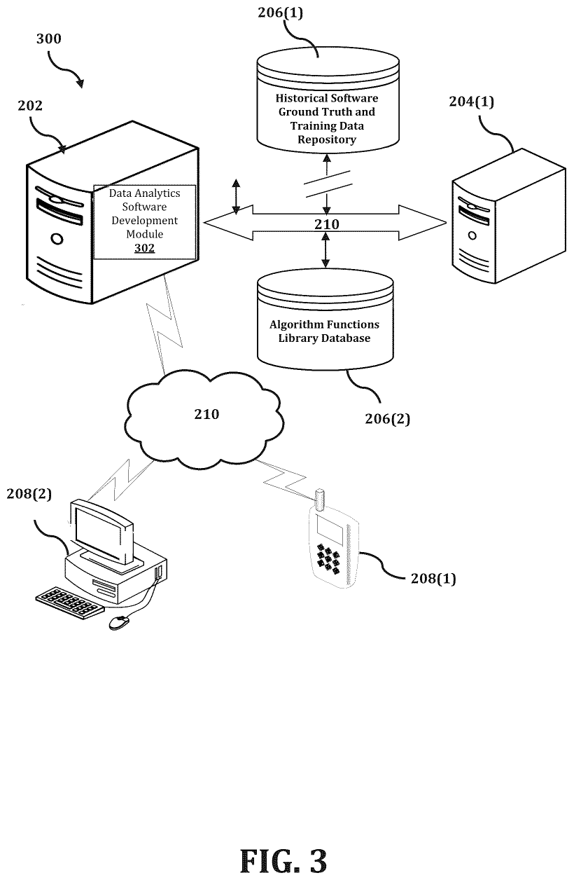

The DAPCRM device 202 is described and illustrated in FIG. 3 as including a data analytics software development module 302, although it may include other rules, policies, modules, databases, or applications, for example. As will be described below, the data analytics software development module 302 is configured to implement a method for using a configuration-based approach to provide a data analytics platform that facilitates efficient feature delivery based on reusability of software modules.

An exemplary process 300 for implementing a mechanism for using a configuration-based approach to provide a data analytics platform that facilitates efficient feature delivery based on reusability of software modules by utilizing the network environment of FIG. 2 is illustrated as being executed in FIG. 3. Specifically, a first client device 208(1) and a second client device 208(2) are illustrated as being in communication with DAPCRM device 202. In this regard, the first client device 208(1) and the second client device 208(2) may be “clients” of the DAPCRM device 202 and are described herein as such. Nevertheless, it is to be known and understood that the first client device 208(1) and/or the second client device 208(2) need not necessarily be “clients” of the DAPCRM device 202, or any entity described in association therewith herein. Any additional or alternative relationship may exist between either or both of the first client device 208(1) and the second client device 208(2) and the DAPCRM device 202, or no relationship may exist.

Further, DAPCRM device 202 is illustrated as being able to access a historical software ground truth and training data repository 206(1) and an algorithm functions library database 206(2). The data analytics software development module 302 may be configured to access these databases for implementing a method for using a configuration-based approach to provide a data analytics platform that facilitates efficient feature delivery based on reusability of software modules.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the DAPCRM device 202 via broadband or cellular communication. Of course, these embodiments are merely exemplary and are not limiting or exhaustive.

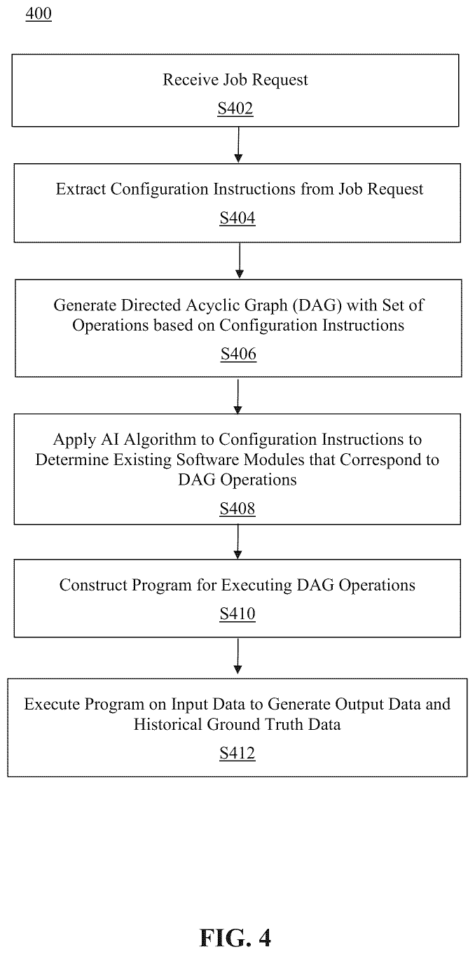

Upon being started, the data analytics software development module 302 executes a process for using a configuration-based approach to provide a data analytics platform that facilitates efficient feature delivery based on reusability of software modules. An exemplary process for using a configuration-based approach to provide a data analytics platform that facilitates efficient feature delivery based on reusability of software modules is generally indicated at flowchart 400 in FIG. 4.

In process 400 of FIG. 4, at step S402, the data analytics software development module 302 receives a job request that corresponds to a feature desired by a user. The feature relates to a data analytics task for which software development is to be conducted in order to generate a software program that is designed to fulfill the job request.

At step S404, the data analytics software development module 302 extracts a set of configuration instructions from the job request. The configuration instructions respectively correspond to operations to be performed within the software program. Then, at step S406, the data analytics software development module 302 transforms the job request into a directed acyclic graph (DAG) that includes a set of operations that correspond to the configuration instructions extracted in step S404. In an exemplary embodiment, each operation included in the set of operations is compatible with a Spark Structured Query Language (SQL) module for structured data processing.

At step S408, the data analytics software development module 302 determines one or more software modules from among a set of previously developed software modules for inclusion in the software program. In an exemplary embodiment, the existing software modules are included in a superset of reusable software modules that are stored in a library, and each such software module may correspond to an algorithm function. In an exemplary embodiment, the library includes operation handler modules that define operation type attributes that correspond to various types of operations that may potentially be included in a software program. In an exemplary embodiment, the library also includes user defined functions (UDFs), each of which has a name attribute that corresponds to an identification of the respective UDF, a class attribute that corresponds to a function type of the respective UDF, and an initialization attribute that corresponds to initializing an instance of the respective UDF.

In an exemplary embodiment, the data analytics software development module matches each operation from the set of operations included in the DAG with at least one reusable software module stored in the library. In an exemplary embodiment, the determination as to which software modules are to be included is performed by applying an artificial intelligence (AI) algorithm that uses a machine learning (ML) technique to select appropriate software modules from the library. In an exemplary embodiment, the AI algorithm is trained by using historical software development data, such as, for example, historical ground truth data.

At step S410, the data analytics software development module 302 constructs the software program. In an exemplary embodiment, the software program includes an assembly and/or combination of the reusable software modules determined as corresponding to DAG operations in step S408.

At step S412, the data analytics software development module 302 executes the software program constructed in step S410. In an exemplary embodiment, a set of input data is received, and then the software program is executed, thereby generating a set of output data and a set of software construction data that is based on a result of the previous steps S402-S410. In particular, the software construction data provides an indication as to whether the desired feature has been effectively captured by the software program and also as to whether the configuration instructions correctly correspond to the reusable software modules used for generating the software program. In an exemplary embodiment, the software construction data may then be appended to the existing historical ground truth data in order to form an enhanced set of training data, and the AI algorithm may be retrained on a regular basis in order to ensure that the AI algorithm is based on a complete a set of historical ground truth and training data as possible.

In an exemplary embodiment, a data analytics platform core engine provides a mechanism for implementing a configuration-based approach that transforms effort that would otherwise be expended to develop software code into a configuration with a Spark SQL module for structured data processing, together with a library of algorithm functions, including operation handlers and UDFs. One goal is to deliver feature faster with less coding effort and more reusability by migrating toward a configuration-based approach with extension points to build reusable components.

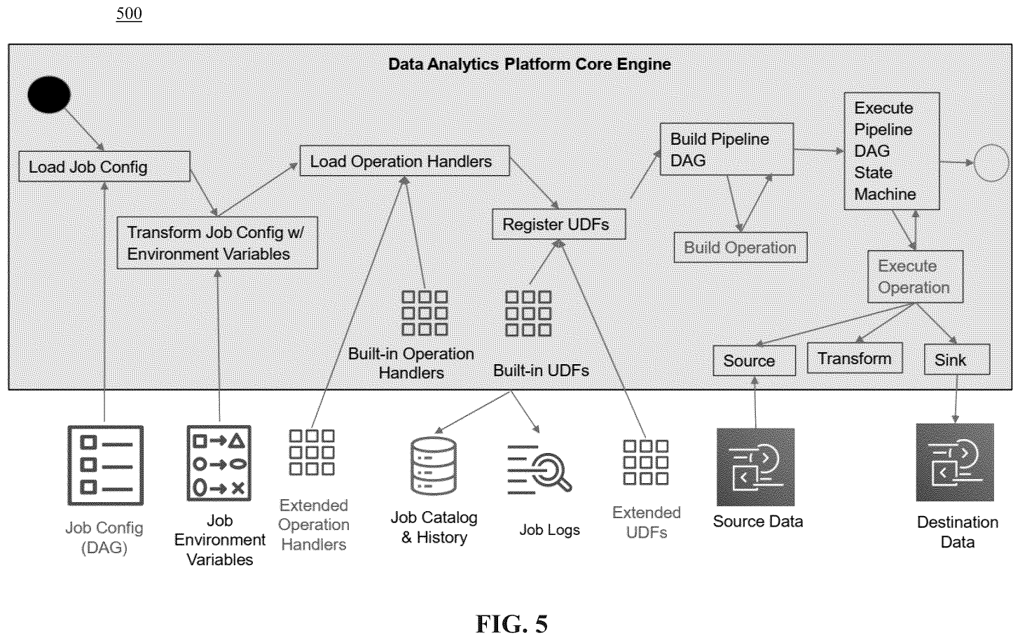

FIG. 5 is a diagram 500 that illustrates a data analytics core engine with extension points for a system that implements a configuration-based approach to provide a data analytics platform that facilitates efficient feature delivery based on reusability of software modules, according to an exemplary embodiment.

As illustrated in diagram 500, in an exemplary embodiment, in a first stage, the data analytics core engine loads a job configuration file as an input thereto. The job configuration may be received from a job configuration server that stores job configuration files in the form of directed acyclic graphs (DAGs), which are directed graphs with no directed cycles. In an exemplary embodiment, each DAG consists of vertices and edges, with each edge directed from one vertex to another, such that following those directions never forms a closed loop. The job configuration schema may include pipeline options, UDFs to register, a list of operations, and runtime substitutions. In an exemplary embodiment, each operation included in the list of operations is represented as a vertex in the associated DAG. In an exemplary embodiment, the types of job configurations may include, for example, a card account balance feature selection job; an autosave job; a job changer job; an idle cash prediction job; a financial plan insight toast job; and an overdraft fee waiver insight job.

In a second stage, the data analytics core engine transforms the job configuration with environmental variables into a set of configuration instructions. The job environment variables may be received from a job environment variables entity that is external to the data analytics core engine.

In a third stage, the data analytics core engine uses the configuration instructions to load a set of operation handlers. In an exemplary embodiment, each operation handler defines an operation type attribute, which is a value returned by the “name ( )” method of an Operation Handler which implements the interface associated with data.analytics.pipeline.spark.operation.handler.OperationHandler. In an exemplary embodiment, the role of an operation handler is to be responsible to create a corresponding operation from the operation configuration in the pipeline setup. In an exemplary embodiment, all operation handlers are automatically registrable through a package scan. The loading of the set of operation handlers may be performed via an internal set of built-in operation handlers that reside within the data analytics platform core engine, and also via extended operation handlers that reside outside of the data analytics platform core engine.

In a fourth stage, the data analytics platform core engine registers a set of UDFs. In an exemplary embodiment, each UDF includes a name attribute that is used for identifying the respective UDF, a class attribute that indicates a class or type of UDF, and an options attribute that is used for initializing an instance of the UDF. The set of UDFs may be accessible via an internal set of built-in UDFs that reside within the data analytics platform core engine, and also via extended UDFs that reside outside of the data analytics platform core engine.

In a fifth stage, the data analytics platform core engine uses the configuration instructions, the loaded operation handlers, and the registered UDFs to build a pipeline DAG that corresponds to the feature that is associated with the job configuration file. The pipeline DAG is then used to build an operation that corresponds to a software program that is designed to provide the desired feature. Then, in a sixth stage, the data analytics platform core engine executes the pipeline DAG state machine that corresponds to the software program constructed therein.

In a seventh stage, the data analytics platform core engine may receive input data from a source, execute an operation on the input data by using the software program, and then export the resulting output data via a sink component to a destination. Finally, in an exemplary embodiment, at any stage, the data analytics platform core engine may export operational data associated with the software construction process to external entities, such as, for example, a job catalog and history database and/or a job log.

Accordingly, with this technology, an optimized process for using a configuration-based approach to provide a data analytics platform that facilitates efficient feature delivery based on reusability of software modules is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for providing a data analytics platform that facilitates efficient feature delivery based on reusability of software modules, the method being implemented by at least one processor, the method comprising:
receiving, by the at least one processor, a job request that corresponds to a feature desired by a user;
transforming, by the at least one processor, the job request into a directed acyclic graph (DAG) that includes a set of operations; and
constructing, by the at least one processor, a software program that is configured to execute the set of operations included in the DAG.

2. The method of claim 1, further comprising:
receiving a set of input data;
generating a set of output data by applying the software program to the input data; and
generating a set of software construction data based on a result of the transforming, the constructing, and the applying of the software program to the input data.

3. The method of claim 2, wherein the transforming comprises extracting, from the job request, a set of configuration instructions that respectively correspond to operations included in the set of operations.

4. The method of claim 2, wherein the constructing comprises retrieving, from a library that stores a plurality of reusable software modules that respectively correspond to algorithm functions, at least one software module that is configured to execute at least one operation from among the set of operations included in the DAG.

5. The method of claim 4, wherein the plurality of reusable software modules includes at least one operation handler module that defines an operation type attribute that corresponds to an operation included in the set of operations.

6. The method of claim 4, wherein the plurality of reusable software modules includes at least one user defined function (UDF) that has a name attribute that corresponds to an identification, a class attribute that corresponds to a function type, and an initialization attribute that corresponds to initializing an instance of the at least one UDF.

7. The method of claim 4, wherein the constructing further comprises applying an artificial intelligence (AI) algorithm that uses a machine learning (ML) technique to determine which software modules, from among the plurality of software modules stored in the library, are configured to execute the at least one operation, and
wherein the AI algorithm is trained by using historical ground truth data.

8. The method of claim 7, further comprising:
appending the software construction data to the historical ground truth data to form an enhanced set of training data; and
retraining the AI algorithm by using the enhanced set of training data.

9. The method of claim 1, wherein each operation included in the set of operations is compatible with a Spark Structured Query Language (SQL) module for structured data processing.

10. A computing apparatus for providing a data analytics platform that facilitates efficient feature delivery based on reusability of software modules, the computing apparatus comprising:
a processor;
a memory; and
a communication interface coupled to each of the processor and the memory,
wherein the processor is configured to:
receive, via the communication interface, a job request that corresponds to a feature desired by a user;
transform the job request into a directed acyclic graph (DAG) that includes a set of operations; and
construct a software program that is configured to execute the set of operations included in the DAG.

11. The computing apparatus of claim 10, wherein the processor is further configured to:
receive, via the communication interface, a set of input data;
generate a set of output data by applying the software program to the input data; and
generate a set of software construction data based on a result of the transformation, the construction, and the application of the software program to the input data.

12. The computing apparatus of claim 11, wherein the processor is further configured to transform the job request into the DAG by extracting, from the job request, a set of configuration instructions that respectively correspond to operations included in the set of operations.

13. The computing apparatus of claim 11, wherein the processor is further configured to construct the software program by retrieving, from a library that stores a plurality of reusable software modules that respectively correspond to algorithm functions, at least one software module that is configured to execute at least one operation from among the set of operations included in the DAG.

14. The computing apparatus of claim 13, wherein the plurality of reusable software modules includes at least one operation handler module that defines an operation type attribute that corresponds to an operation included in the set of operations.

15. The computing apparatus of claim 13, wherein the plurality of reusable software modules includes at least one user defined function (UDF) that has a name attribute that corresponds to an identification, a class attribute that corresponds to a function type, and an initialization attribute that corresponds to initializing an instance of the at least one UDF.

16. The computing apparatus of claim 13, wherein the processor is further configured to construct the software program by applying an artificial intelligence (AI) algorithm that uses a machine learning (ML) technique to determine which software modules, from among the plurality of software modules stored in the library, are configured to execute the at least one operation, and
wherein the AI algorithm is trained by using historical ground truth data.

17. The computing apparatus of claim 16, wherein the processor is further configured to:
append the software construction data to the historical ground truth data to form an enhanced set of training data; and
retrain the AI algorithm by using the enhanced set of training data.

18. The computing apparatus of claim 10, wherein each operation included in the set of operations is compatible with a Spark Structured Query Language (SQL) module for structured data processing.

19. A non-transitory computer readable storage medium storing instructions for providing a data analytics platform that facilitates efficient feature delivery based on reusability of software modules, the storage medium comprising executable code which, when executed by a processor, causes the processor to:
receive a job request that corresponds to a feature desired by a user;
transform the job request into a directed acyclic graph (DAG) that includes a set of operations; and
construct a software program that is configured to execute the set of operations included in the DAG.

20. The storage medium of claim 19, wherein when executed by the processor, the executable code further causes the processor to:
receive a set of input data;
generate a set of output data by applying the software program to the input data; and
generate a set of software construction data based on a result of the transformation, the construction, and the application of the software program to the input data.
